(19) United States
(12) Patent Application Publication
(10) Pub. No.: US 2017/0235190 A1
(43) Pub. Date: Aug. 17, 2017

(54) BACKPLATES AND DIRECT-TYPE BACKLIGHT MODULES

(71) Applicant: Shenzhen China Star Optoelectronics Technology Co., Ltd., Shenzhen, Guangdong (CN)

(72) Inventor: Zuwei ZHANG, Shenzhen, Guangdong (CN)

(73) Assignee: Shenzhen China Star Optoelectronics Technology Co., Ltd., Shenzhen, Guangdong (CN)

(21) Appl. No.: 14/904,191

(22) PCT Filed: Dec. 24, 2015
(86) PCT No.: PCT/CN2015/098777

§ 371 Date: Jan. 11, 2016

(30) Foreign Application Priority Data
Oct. 16, 2015 (CN) 201510677043.8

(51) Int. Cl. G02F 1/1335

(52) U.S. Cl. CPC G02F 1/133608; G02F 1/133605; G02F 1/133603

(57) ABSTRACT

A backplate includes side plates forming a trumpet-shaped opening and a bottom plate connecting the side plates, a convex rib connecting the side plates and the bottom plate is arranged in a corner formed by the side plate and the bottom plate, and the convex rib is arranged to be protrusive and toward an internal of the backplate. A direct-type backlight module is also disclosed. By configuring the convex ribs in the transit corner between the side plates and the bottom plate, the overall rigidity of the backplate is increased without increasing the thickness of the backlight module. At the same time, the side plate may include the first side plate and the second side plate. The second side plate is tiltedly connected between the first side plate and the bottom plate, which extends the length of the backplate so as to ensure the optical performance.

### BACKGROUND OF THE INVENTION

1. Field of the Invention

The present disclosure relates to liquid crystal display technology, and more particularly to a backplate and a direct-type backlight module. 2. Discussion of the Related Art

With respect to Cold Cathode Fluorescent Lamp (CCFL), liquid crystal modules generally adopt direct-type solution. When the backlight source adopts the LEDs, the edge-type solution, when compared to the direct-type solution, may result in a thinner liquid crystal module, and thus the direct-type solution is less adopted. With the development of backlight technology, the thickness of the direct-type backlight module may be close to the thickness of the edge-type backlight module. In addition, as the overall cost of the direct-type solution is smaller than that of the edge-type solution, currently, direct-type solution has been widely adopted by flat liquid crystal modules and curved liquid crystal modules.

With respect to the direct-type backlight module, in order to reduce the overall thickness, not only a light-mixing distance of the lighting box has to be decreased, the backplate structure has to be enhanced. Conventional backplate of the direct-type backlight includes four side plates connecting directly to the bottom plate. The four side plates are of beveled-structures. The structure of the backlight module may be enhanced by adding a strong rib on the bottom plate. This may invisibly increase the thickness of the backlight module, and thus may not contribute to the thinner design.

### SUMMARY

In order to overcome the above problems, a backplate and a direct-type backlight module are proposed wherein the strength of the backplate may be enhanced and the thickness of the liquid crystal module has not been increased.

In one aspect, a backplate includes: side plates forming a trumpet-shaped opening and a bottom plate connecting the side plates, a convex rib connecting the side plates and the bottom plate is arranged in a corner formed by the side plate and the bottom plate, and the convex rib is arranged to be protrusive and toward an internal of the backplate.

Wherein the side plate includes a first side plate and a second side plate, the second side plate connects between the first side plate and the bottom plate, the first side plate is bent outward with respect to the second side plate, the convex rib is arranged in a transit corner formed by connecting the second side plate and the bottom plate.

Wherein an included angle between the second side plate and the bottom plate is about 105 degrees.

Wherein a height of the second side plate with respect to the bottom plate is about ⅓ of a distance between the bottom plate and the opening of the backplate.

Wherein each of edges of the bottom plate includes one convex rib extending along each of the edges of the bottom plate.

Wherein each of edges of the bottom plate includes a plurality of convex ribs spaced apart from each other.

Wherein an outer surface of the bottom plate includes a plurality of reinforcing bars.

Wherein the convex rib is formed by punching along a direction from an outside of the backplate toward the internal of the backplate.

Wherein the convex rib is formed by punching along a direction from an outside of the backplate toward the internal of the backplate.

In another aspect, a direct-type backlight module includes the above backplate, a reflective sheet, a LED light source module, an optical film set, and a plastic frame, and the LED light source module is arranged on the bottom plate.

By configuring the convex ribs in the transit corner between the side plates and the bottom plate, the overall rigidity of the backplate is increased without increasing the thickness of the backlight module. At the same time, the side plate may include the first side plate and the second side plate. The second side plate is tiltedly connected between the first side plate and the bottom plate, which extends the length of the backplate so as to ensure the optical performance.

### BRIEF DESCRIPTION OF THE DRAWINGS

FIG. 1 is a schematic view of the direct-type backlight module in accordance with one embodiment.

FIG. 2 is a partial enlarged view of the convex rib of the direct-type backlight module in accordance with one embodiment.

### DETAILED DESCRIPTION OF THE EMBODIMENTS

Embodiments of the invention will now be described more fully hereinafter with reference to the accompanying drawings, in which embodiments of the invention are shown.

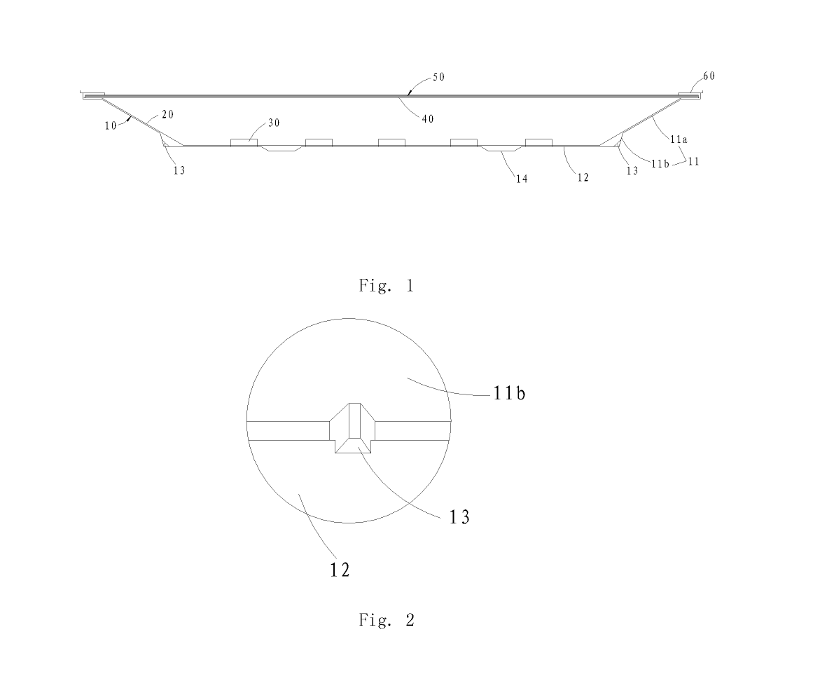

Referring to FIG. 1, the direct-type backlight module includes a backplate 10, a reflective sheet 20, a LED light source module 30, an optical film set 50, and a plastic frame 60. The reflective sheet 20 is arranged on an internal surface of the backplate 10. The LED light source module 30 is arranged on the down substrate 12 and passes through the reflective sheet 20. The backplate includes side plates 11 forming a trumpet-shaped opening and a bottom plate 12 connecting the side plates 11. A convex rib 13 connecting the side plates 11 and the bottom plate 12 is arranged in the corner formed by the side plate 11 and the bottom plate 12, and the convex rib 13 is arranged to be protrusive and toward an internal side. The side plate 11 includes a first side plate 11a and a second side plate 11b. The second side plate 11b connects between the first side plate 11a and the bottom plate 12. The first side plate 11a is bent outward with respect to the second side plate 11b. The convex rib 13 is arranged in a transit corner formed by the second side plate 11b and the bottom plate 12.

The opening of the backplate 10 is provided with a diffusing plate 40 and the optical film set 50 in turn. Afterward, the plastic frame 60 is configured to limit the diffusing plate 40 and the optical film set 50. The light beams emitted by the LED light source module 30 are reflected by the reflective sheet 20, and emit out after passing through the diffusing plate 40 and the optical film set 50 in turn.

By configuring the convex rib 13 within the corner inside the backplate, the deformation resistance of the backplate may be effectively enhanced without increasing the height of the backplate, and thus may be widely adopted in a variety of flat or curved liquid crystal modules. At the same time, the length of the bottom plate 12 has been extended to an outer side of the extended line of the first side plate 11a, and the second side plate 11b is tiltedly connected between the first side plate 11a and the bottom plate 12, and the second side plate 11b respectively forms an angle with the first side plate 11a and the with the bottom plate 12. As such, the convex rib 13 is arranged without affecting the acute angle between the first side plate 11a and the bottom plate 12, which ensures the optical performance of the first side plate 11a.

In the embodiment, the convex rib 13 is formed by punching along a direction from outside of the backplate toward inside of the backplate. The process is easy and only a few components are included. The included angle between the second side plate 11b and the bottom plate 12 is an obtuse angle, i.e., 105 degrees. The height of the second side plate 11b with respect to the bottom plate 12 is about ⅓ of the distance between the bottom plate 12 and the opening of the backplate.

Referring to FIG. 2, each of the edges of the bottom plate 12 includes a plurality of wedge-shaped convex rib 13 spaced apart from each other. The edge portion of the convex rib 13 is a rectangular parallel to the bottom plate 12, and each of the sidewalls of the convex rib 13 is trapezium-shaped. In this way, the convex rib 13 may support the backplate in every directions, and all of the convex ribs 13 form a strengthen structure in the bottom of the backplate.

In other embodiments, each of the edges of the bottom plate 12 may include only one convex rib 13. The convex rib 13 covers the corresponding corner along each of the edges of the bottom plate 12.

The convex rib 13 arranged in the corner enhances the overall rigidity of the backplate. The outer surface of the bottom plate 12 may include a plurality of reinforcing bars 14 that are slightly protrusive from the outer surface. In this way, the overall height of the backplate is still small.

By configuring the convex ribs in the transit corner between the side plates and the bottom plate, the overall rigidity of the backplate is increased without increasing the thickness of the backlight module. At the same time, the side plate may include the first side plate and the second side plate. The second side plate is tiltedly connected between the first side plate and the bottom plate, which extends the length of the backplate so as to ensure the optical performance.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backplate, comprising:
side plates forming a trumpet-shaped opening and a bottom plate connecting the side plates, a convex rib connecting the side plates and the bottom plate is arranged in a corner formed by the side plate and the bottom plate, and the convex rib is arranged to be protrusive and toward an internal of the backplate.

2. The backplate as claimed in claim 1, wherein the side plate comprises a first side plate and a second side plate, the second side plate connects between the first side plate and the bottom plate, the first side plate is bent outward with respect to the second side plate, the convex rib is arranged in a transit corner formed by connecting the second side plate and the bottom plate.

3. The backplate as claimed in claim 2 wherein an included angle between the second side plate and the bottom plate is about 105 degrees.

4. The backplate as claimed in claim 2, wherein a height of the second side plate with respect to the bottom plate is about ⅓ of a distance between the bottom plate and the opening of the backplate.

5. The backplate as claimed in claim 1, wherein each of edges of the bottom plate comprises one convex rib extending along each of the edges of the bottom plate.

6. The backplate as claimed in claim 1, wherein each of edges of the bottom plate comprises a plurality of convex ribs spaced apart from each other.

7. The backplate as claimed in claim 1, wherein an outer surface of the bottom plate comprises a plurality of reinforcing bars.

8. The backplate as claimed in claim 1, wherein the convex rib is formed by punching along a direction from an outside of the backplate toward the internal of the backplate.

9. The backplate as claimed in claim 2, wherein the convex rib is formed by punching along a direction from an outside of the backplate toward the internal of the backplate.

10. A direct-type backlight module, comprising:
a backplate, a reflective sheet, a LED light source module, an optical film set, and a plastic frame, the backplate comprises side plates forming a trumpet-shaped opening and a bottom plate connecting the side plates, a convex rib connecting the side plates and the bottom plate is arranged in a corner formed by the side plate and the bottom plate, and the convex rib is arranged to be protrusive and toward an internal of the backplate, and the LED light source module is arranged on the bottom plate.

11. The direct-type backlight module as claimed in claim 10, wherein the side plate comprises a first side plate and a second side plate, the second side plate connects between the first side plate and the bottom plate, the first side plate is bent outward with respect to the second side plate, the convex rib is arranged in a transit corner formed by connecting the second side plate and the bottom plate.

12. The direct-type backlight module as claimed in claim 11, wherein an included angle between the second side plate and the bottom plate is about 105 degrees.

13. The direct-type backlight module as claimed in claim 11, wherein a height of the second side plate with respect to the bottom plate is about ⅓ of a distance between the bottom plate and the opening of the backplate.

14. The direct-type backlight module as claimed in claim 10, wherein each of edges of the bottom plate comprises one convex rib extending along each of the edges of the bottom plate.

15. The direct-type backlight module as claimed in claim 10, wherein each of edges of the bottom plate comprises a plurality of convex ribs spaced apart from each other.

16. The direct-type backlight module as claimed in claim 10, wherein an outer surface of the bottom plate comprises a plurality of reinforcing bars.

17. The direct-type backlight module as claimed in claim 10, wherein the convex rib is formed by punching along a direction from an outside of the backplate toward the internal of the backplate.

18. The direct-type backlight module as claimed in claim 11, wherein the convex rib is formed by punching along a direction from an outside of the backplate toward the internal of the backplate.
